(19) United States
(12) Patent Application Publication
(10) Pub. No.: US 2026/0128998 A1
(43) Pub. Date: May 7, 2026

(54) ROLE-BASED TELEMETRY

(71) Applicant: HEWLETT PACKARD ENTERPRISE DEVELOPMENT LP, Spring, TX (US)

(72) Inventors: Tathagata Nandy, Bangalore (IN); Renjith Vijayan, Bangalore (IN); Venkatavaradhan Devarajan, Bangalore (IN); Vijeesh Erankotte Panayamthatta, Bangalore (IN); Vishnu Govind Mohanakumar Kusumakumari, Bangalore (IN); Vinay Kumar Vishwakarma, Bangalore (IN)

(21) Appl. No.: 19/041,662

(22) Filed: Jan. 30, 2025

(30) Foreign Application Priority Data
Nov. 6, 2024 (IN) 202441085084

(51) Int. Cl. H04L 47/2483

(52) U.S. Cl. CPC H04L 47/2483

(57) ABSTRACT

In a network, a network device can determine a role for a client device coupled to a first port of the network device. The network device can then determine a set of telemetry parameters associated with the role. The network device can also determine a flow identifier of a data flow received from the client device via the first port. Subsequently, the network device can identify a respective packet in the data flow associated with the flow identifier. The network device can then record, based on a telemetry process of the network device, the set of telemetry parameters associated with the packet.

### BACKGROUND

A network device, such as a switch, may support different network technologies, such as network telemetry. For example, the network device can collect data from packets of different data flows and provide the collected data to a network analyzer.

### BRIEF DESCRIPTION OF THE FIGURES

FIG. 1A illustrates an example of a network supporting role-based telemetry for client devices, in accordance with an aspect of the present application.

FIG. 1B illustrates an example of a network supporting role-based telemetry for a roaming client device, in accordance with an aspect of the present application.

FIG. 2 illustrates examples of respective mappings between a role and a corresponding set of telemetry parameters, in accordance with an aspect of the present application.

FIG. 3A presents a flowchart illustrating an example of a process of a network device applying role-based telemetry on a data flow from a client device, in accordance with an aspect of the present application.

FIG. 3B presents a flowchart illustrating an example of a process of a network device applying role-based telemetry on a reverse data flow destined to a client device, in accordance with an aspect of the present application.

FIG. 4 presents a flowchart illustrating an example of a process of a network device applying telemetry on a packet from a client device, in accordance with an aspect of the present application.

FIG. 5 presents a flowchart illustrating an example of a process of a network device applying role-based telemetry on a data flow from a roaming client device, in accordance with an aspect of the present application.

FIG. 6 illustrates an example of a computing system facilitating role-based telemetry, in accordance with an aspect of the present application.

FIG. 7 illustrates an example of a computer-readable medium (CRM) facilitating role-based telemetry, in accordance with an aspect of the present application.

In the figures, like reference numerals refer to the same figure elements.

### DETAILED DESCRIPTION

The volume of traffic generated by various applications on user devices continues to increase. To efficiently forward and manage the traffic in a network, the network devices can be equipped with versatile capabilities, such as role-based traffic segmentation (RBTS). Since the devices with the same roles form a device group, RBTS can also be referred to as group-based traffic segmentation (GBTS). Typically, when a client device is coupled to a network, the client device can become associated with a role, which corresponds to a set of privileges allocated to the client device. If a packet is sent to the client device (i.e., the client device is the destination of the packet), the role of the client device can be the destination role of the packet. On the other hand, if a packet is sent from the client device (i.e., the client device is the source of the packet), the role of the client device can be the source role of the packet.

A set of segmentation policies can indicate whether a destination role is allowed to receive traffic from a source role. For example, in an enterprise network, a client device in the engineering group can be associated with an “engineer” role. Consequently, the client device can receive traffic from the source roles (e.g., a “developer” role) that are allowed to send traffic to the engineer role. However, if the client device is associated with a “guest” role, the client device may not receive traffic from the developer role. Therefore, if a client device is not allowed to receive a packet from a source role, the network device coupled to the client device can refrain from forwarding the packet to the client device and may drop the packet. In this way, traffic segmentation can separate network traffic based on roles.

The aspects described herein address the problem of relying on manual configuration for performing telemetry for a client device by (i) maintaining a mapping between a role and a corresponding set of parameters associated with telemetry; and (ii) upon determining the role of a client device, recording values of the set of parameters associated with the role from the packets to and from the client device. These parameters can be referred to as telemetry parameters. When a client device authenticates itself based on the corresponding credentials, the network device can determine a role for the client device based on the authentication. The network device can then obtain the telemetry parameters (i.e., the parameters associated with telemetry) mapped to the role. The telemetry process of the network device can then start recording values of the telemetry parameters from the packets to and from the client device. Here, the telemetry process can be a piece of software running on at least one processing resource of the network device and can record values of the telemetry parameters from the packets to and from the client device. As a result, the network device can efficiently perform telemetry for the client device without requiring manual configuration.

Currently, when a client device is coupled to a port of a network device, an administrator configures the telemetry process of the network device to record the values of certain telemetry parameters from the packets received at the port. In addition, the network device may also receive packets destined to the client device via an upstream port coupled to other network devices. Hence, the administrator may also configure the upstream port for recording the telemetry parameters from the packets destined to the client device. Consequently, for both directions of traffic, the telemetry process can become port dependent. Furthermore, if the client device roams or migrates to a new port (i.e., becomes coupled to the new port), the administrator needs to configure the telemetry parameters for the new port. As a result, whenever a client device is coupled to the network device, the administrator needs to manually configure the telemetry parameters to be recorded. This process can be tedious and error prone.

To address this issue, a respective role can be associated with a corresponding set of telemetry parameters. When a client device is coupled to a network device, the network device can determine the role of the client device based on its credentials. For example, if a network is a closed-access network (i.e., not openly accessible), such as an enterprise network, the network can provide access to a client device based on the authentication of the client device. In other words, the client device can send and receive packets via the network upon authentication. Accordingly, to gain access to the network via the network device, the user of the client device may authenticate the client device based on the credentials of the user. Examples of the credentials can include, but are not limited to, a username and password combination, a smartcard, a user biometric, a one-time code (OTC), an approval from an authentication application, and a combination thereof. Based on the authentication, the network device can allocate a role to the client device. If the user is an employee of the enterprise, the role can be an “employee” role. Similarly, if the user is a temporary visitor, the role can be a “guest” role.

For a respective role, the network device can be preconfigured with a set of telemetry parameters. Here, the network device can maintain a mapping between the role and the corresponding telemetry parameters. An administrator may predetermine the set of telemetry parameters for a respective role. The mapping can be stored in the memory of the network device. When the network device detects the client device coupled to a port, the network device can determine the role for the client device (e.g., employee, guest, etc.). Based on the mapping, the network device can determine, using the telemetry process, the values of the set of telemetry parameters for a respective data flow to and from the client device. The telemetry process can record the respective values of the set of telemetry parameters associated with the role from the packets of these data flows.

In some examples, the network device can use an Internet Protocol Flow Information Export (IPFIX) protocol to record the telemetry parameters. IPFIX may support a set of parameters, the values of which can be collected from the packets of a respective data flow. The administrator may select a corresponding subset of these parameters for a respective role. As a result, when the network device determines the role of the client device, the network device can determine a particular subset of parameters (i.e., the telemetry parameters) associated with the role. The network device can then record the values of these parameters using IPFIX and report the recorded values to a collector. The collector can be any device that can obtain and analyze the recorded values. The collector can be a management device, such as a network orchestrator, that can configure and provision the network devices. The administrator may also predetermine the collector in accordance with the IPFIX protocol.

The network device can determine a flow identifier for a respective data flow from the client device. The flow identifier can include a tuple [source Internet Protocol (IP) address, destination IP address, source protocol port, destination protocol port, transport protocol]. For example, if the source IP address is X, the destination IP address is Y, the source protocol port is A, the destination protocol port is B, and the transport protocol is Transmission Control Protocol (TCP), the flow identifier can be the tuple [X, Y, A, B, TCP]. Furthermore, if the transport protocol is TCP, a respective protocol port can be a TCP port. Based on the flow identifier, the network device can also identify a reverse data flow destined to the client device. Here, the flow identifier of the reverse data flow can then be the tuple [Y, X, B, A, TCP]. The network device can detect the reverse data flow based on this tuple at the upstream port (i.e., the port receiving traffic destined to the client device). The network device can then determine that the reverse data flow is destined to the client device. Accordingly, the network device can determine the role of the client device and automatically determine, using the telemetry process, the values of the telemetry parameters for the packets of the reverse data flow (i.e., packets destined to the client device) at the upstream port based on the role.

As a result, if the client device initiates a new data flow to a different destination, the network device can determine, using the telemetry process, the values of the telemetry parameters for the new data flow and the corresponding reverse data flow based on the role. In this way, the network device can efficiently record telemetry parameters from a respective data flow to and from the client device based on the role of the client device. Furthermore, when the client device roams to another location, such as a different port of the network device or another network device, the telemetry process can determine the values of the telemetry parameters based on the role of the client device. For example, if a new network device detects the client device via one of its ports, the network device can determine the role of the client device. Subsequently, the network device can determine, using the telemetry process, the values of the same telemetry parameters associated with the role of the client device for a respective data flow to and from the client device.

In this disclosure, the term “switch” is used in a generic sense, and it can refer to any standalone network device or fabric switch operating in any network layer. “Switch” should not be interpreted as limiting examples of the present invention to layer-2 networks. Any device that can forward traffic to an external device or another switch can be referred to as a “switch.” Furthermore, if the switch facilitates communication between networks, the switch can be referred to as a gateway switch. Any physical or virtual device (e.g., a virtual machine or switch operating on a computing device) that can operate as a network device and forward traffic to an end device can be referred to as a “switch.” If the switch is a virtual device, the switch can be referred to as a virtual switch. Examples of a “switch” include, but are not limited to, a layer-2 switch, a layer-3 router, a routing switch, a component of a Gen-Z network, or a fabric switch comprising a plurality of similar or heterogeneous smaller physical and/or virtual switches.

The term “packet” refers to a group of bits that can be transported together across a network. “Packet” should not be interpreted as limiting examples of the present invention to a particular layer of a network protocol stack. “Packet” can be replaced by other terminologies referring to a group of bits, such as “message,” “frame,” “cell,” “datagram,” or “transaction.” Furthermore, the term “port” can refer to an endpoint of a link that can receive or transmit data. “Port” can also refer to the hardware, software, and/or firmware logic that can facilitate the operations of that port.

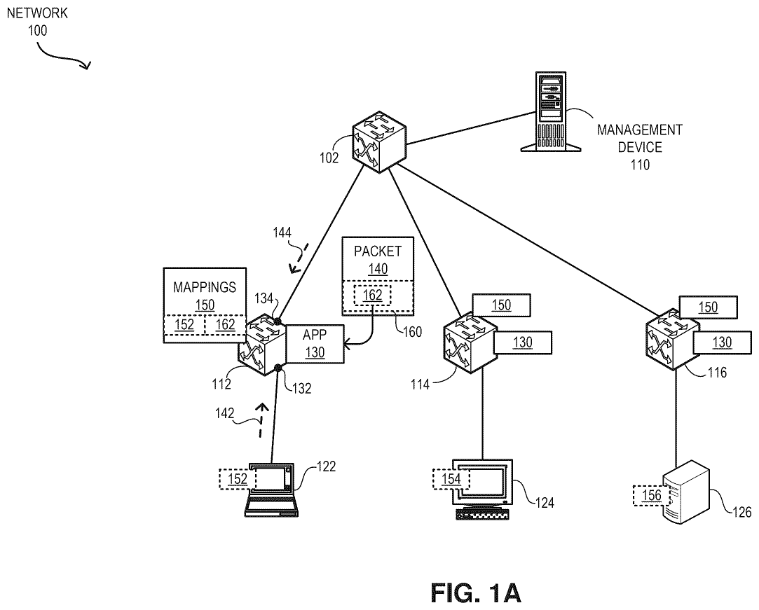

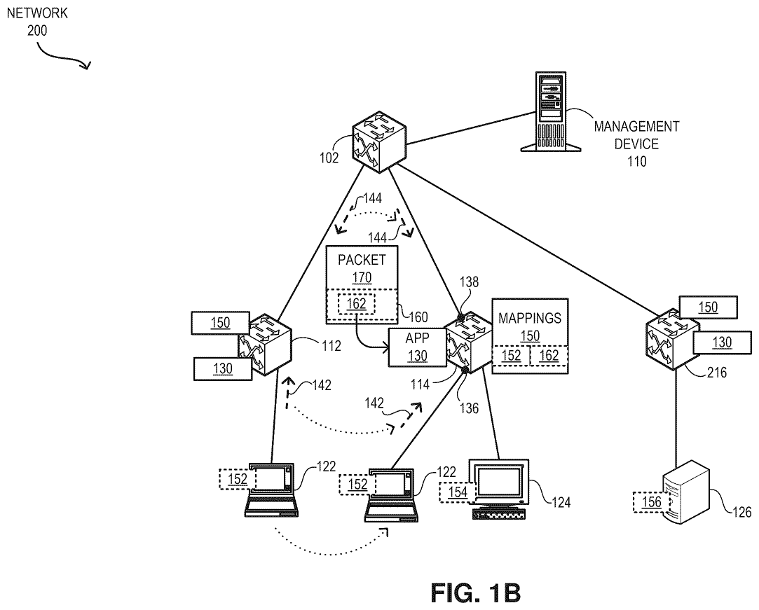

FIG. 1A illustrates an example of a network supporting role-based telemetry for client devices, in accordance with an aspect of the present application. A network 100 can include a number of network devices (e.g., switches), and may include network devices, such as layer-2 and layer-3 hops, and tunnels. In some examples, network 100 can be an Ethernet network, InfiniBand network, or other network, and may use a corresponding communication protocol, such as IP, FibreChannel over Ethernet (FCOE), or other protocols. Network 100 can include network devices 102, 112, 114, and 116. These network devices can be individual physical network devices or networking units (e.g., switching units, such as switchblades) within a chassis. Network device 102 may be coupled to an external network (not shown in FIG. 1A) (e.g., a wide-area network (WAN), such as the Internet).

A respective network device in network 100 can be assigned a media access control (MAC) address and an IP address and can include at least one processing resource. Examples of a processing resource can include, but are not limited to, a processor core, a graphics processing unit (GPU), and a tensor processing unit (TPU). The network device can also include at least one non-transitory computer-readable medium storing instructions that, when executed by the processing resource, causes the processing resource to perform one or more operations. The network device can further include forwarding hardware (e.g., the application-specific integrated circuit (ASIC) of the network device, which can at least incorporate a ternary content-addressable memory (TCAM)).

To efficiently forward and manage the traffic in network 100, network devices 102, 112, 114, and 116 can facilitate role-based or group-based traffic segmentation. Typically, when client devices 122, 124, and 126 become coupled to network 100, client devices 122, 124, and 126 can become associated with roles 152, 154, and 156, respectively. Client devices 122, 124, and 126 can be coupled to network devices 112, 114, and 116, respectively, via corresponding ports. When client device 122 is coupled to network device 112, network device 112 can determine a role 152 of client device 122 based on its credentials. For example, network 100 can provide access to client device 122 based on the authentication of client device 122. In other words, client device 122 can send and receive packets via network 100 upon authentication.

Accordingly, to gain access to network 100 via network device 112, the user of client device 122 may authenticate client device 122 based on the credentials of the user. Examples of the credentials can include, but are not limited to, a username and password combination, a smartcard, a user biometric, an OTC, an approval from an authentication application, and a combination thereof. Based on the authentication, network device 112 can allocate role 152 to client device 122. If the user is an employee of the enterprise, role 152 can be an “employee” role. Similarly, if the user is a temporary visitor, role 152 can be a “guest” role. Similarly, when client devices 124 and 126 are coupled to network devices 114 and 116, respectively, network devices 114 and 116 can determine roles 154 and 156 for client devices 124 and 126, respectively, based on their corresponding credentials.

During operation, client device 122 can be coupled to port 132 of network device 112. An administrator can then configure the telemetry parameters for client device 122 in network device 112. Accordingly, network device 112 can start recording the values of the telemetry parameters from the packets received at port 132. Network device 112 may also receive packets destined to client device 122 via upstream port 134 coupled to network device 102. Therefore, the administrator may also configure the telemetry parameters for client device 122 at port 134. Consequently, for both directions of traffic, recording the telemetry parameters at network device 112 can become port dependent.

Furthermore, client device 122 may roam or migrate to a new port where client device 122 becomes coupled to the new port (e.g., another port of network device 112 or another network device). Under such circumstances, the administrator needs to configure the telemetry parameters for the new port. As a result, whenever client device 122 is coupled to network device 112, the administrator needs to manually configure the telemetry parameters to be recorded. This process can be tedious and error prone.

To address this issue, roles 152, 154, and 156 can be associated with corresponding sets of telemetry parameters. For each of roles 152, 154, and 156, network devices 112, 114, and 116 can be preconfigured with a corresponding set of telemetry parameters. Network devices 112, 114, and 116 can maintain respective mappings 150 between roles 152, 154, and 156 and the corresponding telemetry parameters. For example, mappings 150 can include a mapping between role 152 and a set of telemetry parameters 162. An administrator may enable role-based telemetry at network devices 112, 114, and 116 and can predetermine the set of telemetry parameters for a respective role. Mappings 150 can be stored in a data structure in respective memories of network devices 112, 114, and 116. If the role-based telemetry is enabled, upon detecting client device 122 via port 132, network device 112 can determine role 152 for client device 122. Based on mappings 150, network device 112 can determine that telemetry parameters 162 is associated with role 152. Accordingly, network device 112, can determine, using the telemetry process, the values of telemetry parameters 162 for a data flow 142 received at port 132 from client device 122. Here, the telemetry process of network device 112 can start recording the respective values of telemetry parameters 162 associated with role 152 from packets of data flow 142.

For example, when network device 112 receives a packet 140 via port 132, network device 112 can determine that packet 140 is in data flow 142 based on the flow identifier of data flow 142. The flow identifier can include a tuple [source IP address, destination IP address, source protocol port, destination protocol port, transport protocol]. Here, the source IP address can be the IP address of client device 122. If the source IP address is X, the destination IP address is Y, the source protocol port is A, the destination protocol port is B, and the transport protocol is TCP, the flow identifier can be the tuple [X, Y, A, B, TCP]. Furthermore, a respective protocol port can be a TCP port if the transport protocol is TCP. When network device 112 detects these IP addresses, ports, and transport protocol in packet 140, network device 112 can determine packet 140 to be in data flow 142. Network device 112 can then obtain the values of telemetry parameters 162 from packet 140. Even if client device 112 initiates a new data flow to a different destination, the network device can determine, using the telemetry process, the values of telemetry parameters 162 for the new data flow and the corresponding reverse data flow based on the role.

Network device 112 can record the values of telemetry parameters 162 from packet 140. In some examples, network device 112 can use an application 130, such as the IPFIX daemon running on network device 112. Here, application 130 can comprise the telemetry process of network device 112. The IPFIX daemon can facilitate the IPFIX protocol on network device 112 and can be a piece of software running on one or more processing resources of network device 112. Application 130 can perform a deep-packet inspection (DPI) on packet 140 and collect the respective values of a set of parameters 160. Performing DPI in packet 140 can include inspecting the content of header fields and payload of packet 140 that are not needed to forward packet 140 from network device 112. Here, parameters 160 can be the set of parameters that can be collected by the IPFIX protocol. Telemetry parameters 162 can be a subset of parameters 160 preselected by an administrator. Hence, the administrator can determine which subset of parameters 160 is to be associated with role 152. This subset of parameters can then become telemetry parameters 162 associated with role 152.

Upon determining telemetry parameters 162 from mappings 150, network device 112 can perform DPI on packet 140 and record the values of telemetry parameters 162 from packet 140. Network device 112 can report the values to a collector. For example, network device 112 can use application 130 to record the values of telemetry parameters 162 and report them to the collector. The collector can be any device that can obtain and analyze the recorded values. The collector can be a management device 110, which can be the network orchestrator of network 100, that can configure and provision the network devices of network 100. The administrator may also predetermine management device 100 as the collector in accordance with the IPFIX protocol. For example, the administrator can configure application 130 on network devices 112, 114, and 116 to indicate management device 110 as the collector (e.g., as an IPFIX configuration parameter). It should be noted that any device capable of receiving the recorded values based on the IPFIX protocol can be the collector.

Based on the tuple [X, Y, A, B, TCP], the network device can also identify a reverse data flow 144 destined to client device 122. Here, the flow identifier of data flow 144 can then be the tuple [Y, X, B, A, TCP]. Network device 112 can detect data flow 144 based on the tuple [Y, X, B, A, TCP] at port 134 (i.e., the port receiving data flow 144). Here, IP address X of client device 122 can be the destination address of data flow 144. Network device 112 can then determine that data flow 144 is destined to client device 122. Accordingly, network device 112 can determine role 152 of client device 122 from mappings 150. Subsequently, network device 112 can determine, using the telemetry process (e.g., application 130), the values of telemetry parameters 162 for the packets of data flow 144 (i.e., packets destined to client device 122) at port 134 based on role 152. In this way, network device 112 can facilitate efficient port-based telemetry in network 100.

FIG. 1B illustrates an example of a network supporting role-based telemetry for a roaming client device, in accordance with an aspect of the present application. During operation, client device 122 may roam to another location and can become coupled to port 136 of network device 114. When network device 114 detects client device 122 via port 136, network device 114 can determine role 152 of client device 122. Furthermore, since client device 122 becomes coupled to network device 114, data flows 142 and 144 are also moved to network device 114. In other words, subsequent packets of data flows 142 and 144 are forwarded via network device 114 instead of network device 112. In this example, network device 114 can receive data flow 142 at port 136 and data flow 144 at port 138.

Based on mappings 150, network device 114 can determine that telemetry parameters 162 is associated with role 152. Accordingly, network device 114 can use the telemetry process for data flow 142 at port 136 and start recording the respective values of telemetry parameters 162 associated with role 152 from packets of data flow 142. Here, the telemetry process can be a piece of software (e.g., application 130) running on at least one processing resource of network device 114 and can record values of telemetry parameters 162 from the packets to and from client device 122. For example, when network device 114 can receive a packet 170 via port 136, network device 114 can determine that packet 170 is in data flow 142 based on the flow identifier of data flow 142. To forward packet 170, the forwarding hardware of network device 114 can inspect the source and destination IP addresses, protocol ports, and transport protocol. When network device 114 detects the IP addresses based on the inspection, ports, and transport protocol of the tuple [X, Y, A, B, TCP] in packet 170, network device 114 can determine packet 170 to be in data flow 142. Network device 114 can then obtain the values of telemetry parameters 162 from packet 170. Network device 112 can use application 130 to record the values of telemetry parameters 162 from packet 170.

Based on the tuple [Y, X, B, A, TCP], the network device can also identify data flow 144 destined to client device 122. Network device 114 can detect data flow 144 based on the tuple [Y, X, B, A, TCP] at port 138 (i.e., the port receiving data flow 144 after the roaming of client device 122). Here, IP address X of client device 122 can remain the destination address of data flow 144 after the roaming of client device 122. Hence, network device 114 can then determine that data flow 144 is destined to client device 122. Accordingly, network device 114 can determine role 152 of client device 122 from mappings 150. Subsequently, network device 114 can start recording the values of telemetry parameters 162 from the packets in data flow 144 (i.e., packets destined to client device 122) at port 138.

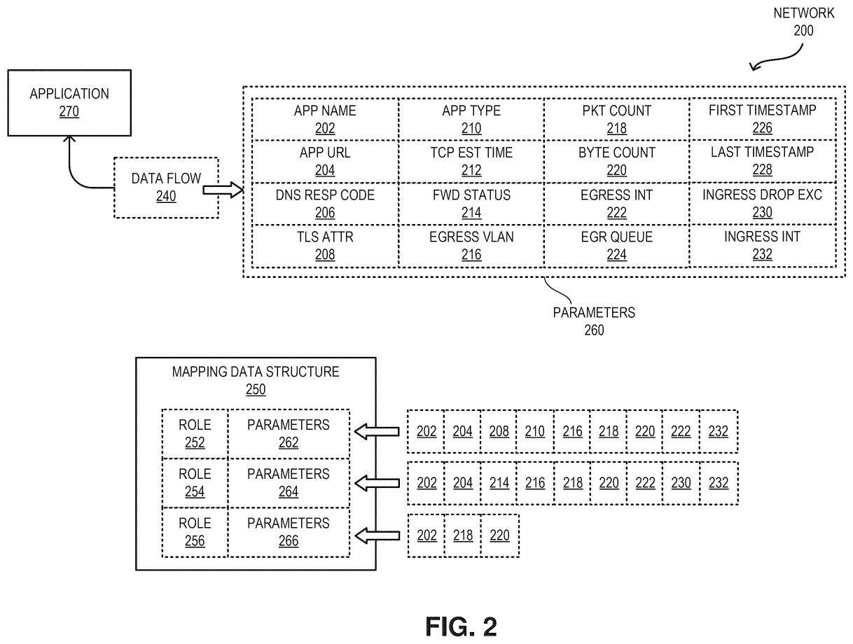

FIG. 2 illustrates examples of respective mappings between a role and a corresponding set of telemetry parameters, in accordance with an aspect of the present application. A number of roles 252, 254, and 256 can be defined in network 200. Roles 252, 254, and 256 can be associated with corresponding sets of telemetry parameters. For each of roles 252, 254, and 256, the network devices in network 200 can be preconfigured with a corresponding set of telemetry parameters. These network devices can maintain a mapping data structure 250 that stores respective mappings between roles 252, 254, and 256 and corresponding sets of telemetry parameters 262, 264, and 266, respectively. An administrator may predetermine the set of telemetry parameters for a respective role. Mapping data structure 250 can be stored in the memory of the network devices in network 200. When a network device detects a client device, the network device can determine a role for the client device. Based on the mappings in mapping data structure 250, the network device can determine the telemetry parameters associated with the role and use the telemetry process for the client device.

The network device can record the values of a set of parameters 260 from a respective packet of a data flow 240. In some examples, the network device can use an application 270, such as the IPFIX daemon running on the network device. The IPFIX daemon can facilitate the IPFIX protocol on the network device and can be a piece of software running on one or more processing resources of the network device. Application 270 can collect a set of parameters 260, which can be the set of parameters that can be collected by the IPFIX protocol. If data flow 240 is associated with a particular role (e.g., to or from a client device associated with the role), application 270 can record a subset of parameters 260 corresponding to the role. For example, if data flow 240 is associated with role 252, application 270 can record a predetermined subset of parameters 260 as telemetry parameters 262. Similarly, telemetry parameters 264 and 266 can be subsets of parameters 260 corresponding to roles 254 and 256, respectively.

Here, application 270 can support the recording of a set of parameters, the values of which can be collected from the packets of data flow 240. The administrator may select corresponding subsets of these parameters for roles 252, 254, and 256 as telemetry parameters 262, 264, and 266, respectively. In other words, the administrator may preselect which parameters in parameters 260 should be recorded for which role. As a result, when the network device determines a role associated with data flow 240, the network device can determine a particular subset of parameters (i.e., the telemetry parameters) associated with the role. The network device can then record the values of these parameters using application 270 and report the recorded values to the collector. For example, the network device can perform DPI on the packets and determine the respective values of the telemetry parameters.

Parameters 260 associated with data flow 240 can include one or more of: application name 202, application Uniform Resource Locator (URL) 204, Domain Name System (DNS) response code 206, Transport Layer Security (TLS) attributes 208, application type 210, TCP establishment time 212, forwarding status 214, egress virtual local area network (VLAN) 216, packet count 218, byte count 220, egress interface 222, egress queue 224, first (or starting) timestamp 226, last (or ending) timestamp 228, ingress drop exceptions 230, and ingress interface 232. Here, the application in parameters 260 corresponds to the application generating data flow 240, which can be distinct from application 270 that can collect parameters 260 from data flow 240.

Here, application name 202 can indicate the name of the application generating data flow 240, such as Facebook, Yahoo!, Google, YouTube, etc. Application URL 204 can then indicate the URL of the application. If application name 202 indicates “Facebook,” application URL 204 can indicate “www.facebook.com.” Furthermore, DNS response code 206 can include a code that indicates the success or failure of a name lookup request associated with application URL 204. For example, if the name lookup is successful, DNS response code 206 can indicate that there is no error. On the other hand, if the name lookup is unsuccessful, DNS response code 206 can indicate the error that has occurred (e.g., formatting error, server failure, etc.).

TLS attributes 208 can indicate the TLS version used by the application and the type of fingerprinting (e.g., JA3, JA3S, etc.) that can be used to uniquely identify a device, such as the source and destination of data flow 240. Application type 210 can indicate the type of the application, such as audio, video, social media, etc. For example, if application name 202 indicates “Facebook,” application type 210 can indicate “social media.” TCP establishment time 212 can indicate the response time between a client and a server (e.g., between the source and destination of data flow 240). Forwarding status 214 can indicate whether data flow 240 is blocked by a policy (e.g., an access-control list (ACL). Egress VLAN 216 can indicate the outgoing VLAN on which a respective packet of data flow 240 is forwarded. Packet count 218 can indicate the number of packets of data flow 240 that have been forwarded via the network device. Similarly, byte count 220 can indicate the number of bytes of data flow 240 that have been forwarded via the network device.

In addition, egress interface 222 can be the outgoing interface via which a respective packet of data flow 240 is forwarded from the network device. Egress interface 222 can be associated with a number of egress queues (e.g., associated with different priorities, such as Ethernet priorities). Egress queue 224 can then indicate the egress queue that stores the packets of data flow 240 prior to sending them. Timestamps 226 and 228 can indicate the start time and end time of data flow 240. Ingress drop exceptions 230 can indicate a reason for a dropped packet, if any (e.g., a congested queue). Ingress interface 232 can indicate the incoming interface via which a respective packet of data flow 240 is received at the network device.

Depending on the role, the administrator can select a subset of parameters 260 as the telemetry parameters. For example, if role 252 is a guest role, telemetry parameters 262 may typically include application name 202, application URL 204, TLS attributes 208, application type 210, egress VLAN 216, packet count 218, byte count 220, egress interface 222, and ingress interface 232. Furthermore, if role 254 is an employee role, telemetry parameters 264 may typically include application name 202, application URL 204, forwarding status 214, egress VLAN 216, packet count 218, byte count 220, egress interface 222, ingress drop exceptions 230, and ingress interface 232. Moreover, if role 256 is an appliance role (e.g., an appliance, such as an Internet of Things (IoT) device), telemetry parameters 266 may typically include application name 202, packet count 218, and byte count 220. Hence, when the network device can determine the role for a client device, the network device can efficiently select the telemetry parameters associated with the role based on the mappings in mapping data structure 250 and start recording the values of the telemetry parameters.

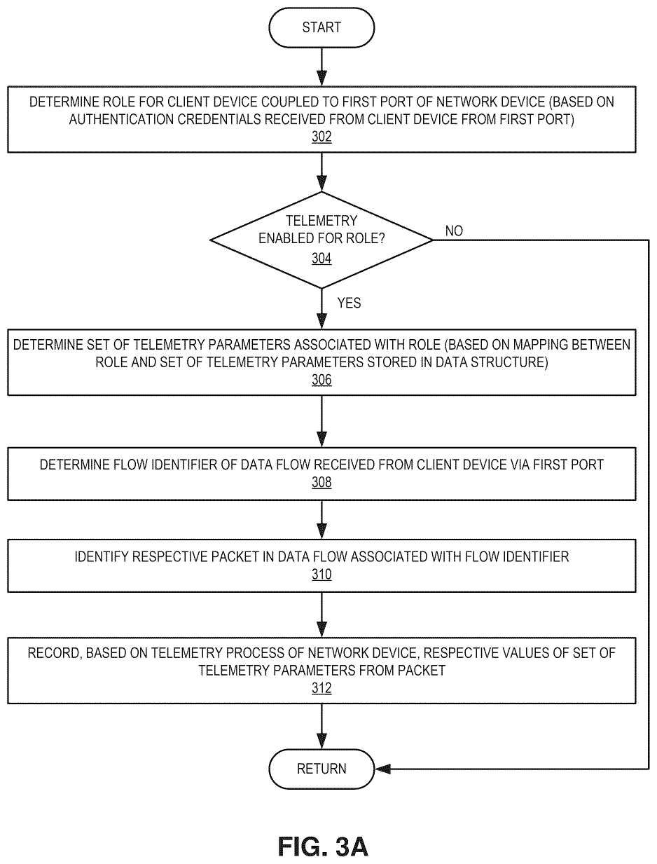

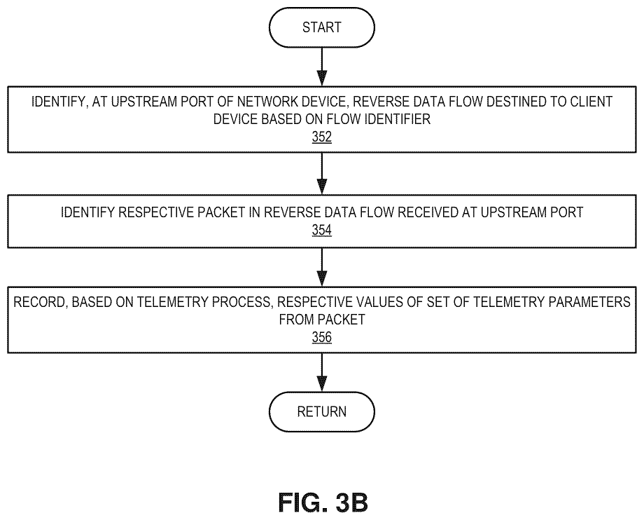

FIG. 3A presents a flowchart illustrating an example of a process of a network device applying role-based telemetry on a data flow from a client device, in accordance with an aspect of the present application. During operation, the network device can determine a role for a client device coupled to a first port of the network device (operation 302). The network device can verify whether the client device is allowed to send and receive packets via the network device by authenticating the client device. Accordingly, the network device can receive authentication credentials of the client device via the first port. In some examples, the network device may determine the role of the client device based on the authentication credentials from the client device via the first port. In the example of FIG. 1A, network device 112 can receive the authentication credentials from client device 122 via port 132. Based on the authentication credentials, network device 112 can determine role 152 for client device 122.

The network device can then determine whether telemetry is enabled for the role (operation 304). An administrator may enable telemetry for the role by associating a set of telemetry parameters to the role. Accordingly, if the network device determines that a set of telemetry parameters is associated with the role in a mapping stored in the memory of the network device, the network device can determine that telemetry is enabled for the role. The network device can then determine the set of telemetry parameters associated with the role (operation 306). In some examples, the network device may determine the set of telemetry parameters based on a mapping between the role and the set of telemetry parameters stored in a data structure. In the example in FIG. 1A, network device 112 can store a mapping between role 152 and a set of telemetry parameters 162 in a data structure in the memory of network device 112. Network device 112 can determine a set of telemetry parameters 162 based on the mapping.

The network device can determine a flow identifier of a data flow received from the client device via the first port (operation 308). The flow identifier can include a tuple [source IP address, destination IP address, source protocol port, destination protocol port, transport protocol]. Since the data flow is received from the client device, the source IP address in the flow identifier can be allocated to the client device. In the example in FIG. 1A, network device 112 can determine a flow identifier for data flow 142 received from client device 122 via port 132. The network device can then identify a respective packet in the data flow associated with the flow identifier (operation 310). When the network device detects the IP addresses, ports, and transport protocol of the flow identifier in a packet, the network device can determine the packet to be in the data flow. In the example in FIG. 1A, network device 112 can detect the IP addresses, ports, and transport protocol of the flow identifier of data flow 142 in packet 140. Hence, network device 112 can determine packet 140 to be in data flow 142.

The network device can then record, based on the telemetry process of the network device, the respective values of the set of telemetry parameters from the packet (operation 312). Here, the telemetry process can be a piece of software running on at least one processing resource of the network device and can record values of the telemetry parameters from the packets to and from the client device. The network device can use an application comprising the telemetry process by recording the values of the set of telemetry parameters from the packet. In some examples, the application can be the IPFIX daemon executing on the network device. The IPFIX daemon can facilitate the IPFIX protocol on the network device and can be a piece of software running on one or more processing resources of the network device. In the example in FIG. 1A, network device 112 can use application 130, which can comprise the telemetry process of network device 112, to record respective values of set of telemetry parameters 162 from packet 140.

FIG. 3B presents a flowchart illustrating an example of a process of a network device applying role-based telemetry on a reverse data flow destined to a client device, in accordance with an aspect of the present application. During operation, the network device can identify, at an upstream port of the network device, a reverse data flow destined to the client device based on the flow identifier (operation 352). The upstream port can be coupled to another device forwarding the reverse data flow to the network device. In the flow identifier, if the source IP address is X, the destination IP address is Y, the source protocol port is A, the destination protocol port is B, and the transport protocol is TCP, the flow identifier can be the tuple [X, Y, A, B, TCP]. Based on the flow identifier, the network device can also identify a reverse data flow destined to the client device. Here, the reverse data flow can correspond to the tuple [Y, X, B, A, TCP]. In the example in FIG. 1A, network device 112 can identify data flow 144 at upstream port 134 based on the flow identifier.

The network device can then identify a respective packet in the reverse data flow received at the upstream port (operation 354). When the network device determines that the IP addresses, ports, and transport protocol in a packet match the tuple [Y, X, B, A, TCP], the network device can determine the packet to be in the reverse data flow. In the example in FIG. 1A, network device 112 can detect packets of data flow 144 based on the flow identifier. The network device can then record, based on the telemetry process, respective values of the set of telemetry parameters from the packet (operation 356). The network device can determine that the reverse data flow is destined to the client device (e.g., based on the destination IP address). Accordingly, the network device can determine the role of the client device and determine the set of telemetry parameters from the corresponding mapping. In the example in FIG. 1A, network device 112 can determine telemetry parameters 162 based on role 152 of client device 122. Subsequently, network device 112 can record respective values of telemetry parameters 162 from the packets of data flow 144 (i.e., packets destined to client device 122) at port 134.

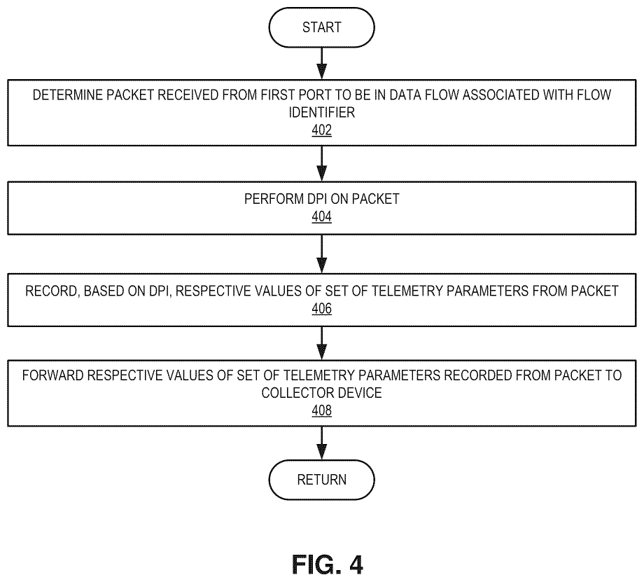

FIG. 4 presents a flowchart illustrating an example of a process of a network device applying telemetry on a packet from a client device, in accordance with an aspect of the present application. During operation, the network device can determine a packet received from the first port to be in the data flow associated with the flow identifier (operation 402). The flow identifier can include a tuple [source IP address, destination IP address, source protocol port, destination protocol port, transport protocol]. When the network device detects the IP addresses, ports, and transport protocol of the flow identifier in a packet, the network device can determine the packet to be in the data flow. In the example in FIG. 1A, network device 112 can detect the IP addresses, ports, and transport protocol of the flow identifier of data flow 142 in packet 140. Hence, network device 112 can determine packet 140 to be in data flow 142.

The network device can then perform DPI on the packet (operation 404) and record, based on the DPI, respective values of the set of telemetry parameters from the packet (operation 406). Upon determining the telemetry parameters, the network device can use the DPI on the packet to determine the respective values indicated in the set of telemetry parameters from the packet based on the DPI. In the example in FIG. 1A, network device 112 can perform DPI on packet 140 and record the values of telemetry parameters 162 from packet 140. The network device can forward respective values of the set of telemetry parameters recorded from the packet to a collector device (operation 408). The collector device can be any device that can obtain the recorded values and analyze them. An administrator may also predetermine the collector device in accordance with the IPFIX protocol. In the example in FIG. 1A, network device 112 can send the recorded values to a collector device, which can be a management device 110 (e.g., the network orchestrator of network 100).

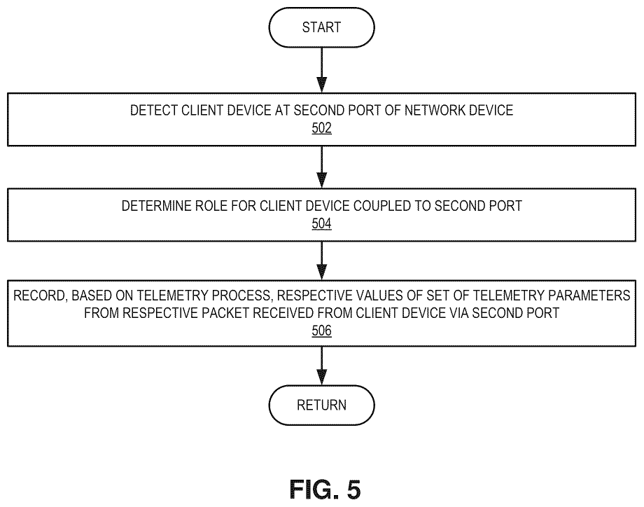

FIG. 5 presents a flowchart illustrating an example of a process of a network device applying role-based telemetry on a data flow from a roaming client device, in accordance with an aspect of the present application. The network device can detect the client device at a second port of the network device (operation 502). Here, the network device and client device can correspond to the network device and client device of FIG. 3A, respectively. Therefore, the client device can roam from the first port to the second port of the network device. In the example in FIG. 1B, client device 122 may roam to another location. The network device can then determine the role of the client device coupled to the second port (operation 504). Based on the authentication of the client device, the network device can determine its role. In the example in FIG. 1B, when network device 114 detects client device 122 via port 136, network device 114 can determine role 152 of client device 122.

The network device can then record, based on the telemetry process, respective values of the set of telemetry parameters from a respective packet received from the client device via the second port (operation 506). When the network device determines that the IP addresses, ports, and transport protocol in a packet match the tuple [Y, X, B, A, TCP] corresponding to the data flow, the network device can determine the packet to be in the reverse data flow. The network device can determine the set of telemetry parameters associated with the role from the corresponding mapping. In the example in FIG. 1B, network device 114 can determine telemetry parameters 162 based on role 152 of client device 122. Subsequently, network device 112 can record respective values of telemetry parameters 162 from packet 170 of data flow 144 at port 136.

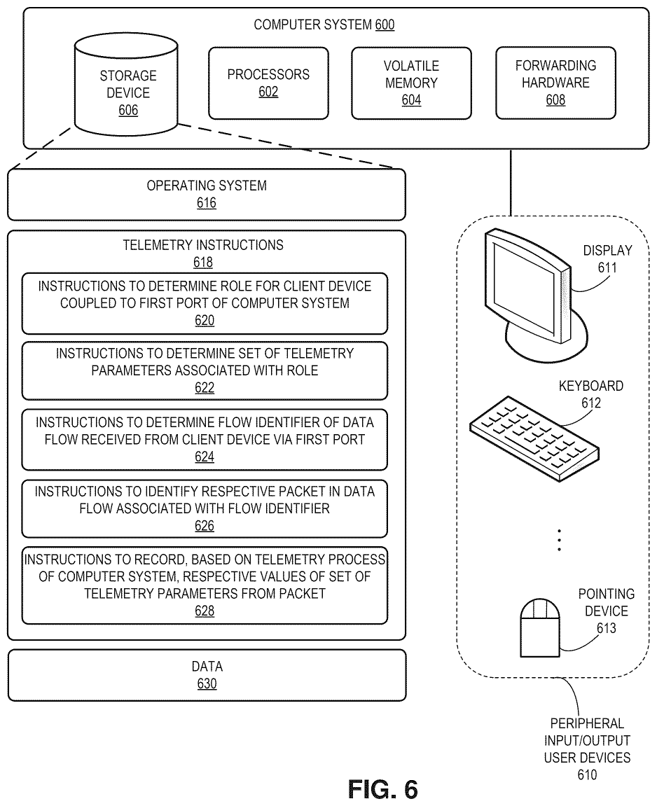

FIG. 6 illustrates an example of a computing system facilitating role-based telemetry, in accordance with an aspect of the present application. Computer system 600 includes one or more processors 602, a memory 604, a storage device 606, and forwarding hardware 608. Processors 602 can include one or more processing resources, such as processor cores, GPUs, and TPUs. Memory 604 can include a volatile memory (e.g., random access memory (RAM)) that serves as a managed memory and can be used to store one or more memory pools. Furthermore, computer system 600 can be coupled to peripheral I/O user devices 610 (e.g., a display device 611, a keyboard 612, and a pointing device 613). Forwarding hardware 608 can include a TCAM. Storage device 606 includes a non-transitory computer-readable storage medium and stores an operating system 616, telemetry instructions 618, and data 630. Computer system 600 may include fewer or more entities or instructions than those shown in FIG. 6.

Telemetry instructions 618 can include instructions, which when executed by computer system 600, can cause computer system 600 to perform methods and/or processes described in this disclosure. Telemetry instructions 618 can be executed on at least one of processors 602, forwarding hardware 608, or a combination thereof. Computer system 600 can be a network device, such as network device 112 in FIGS. 1A and 1B. Specifically, telemetry instructions 618 may include instructions 620 to determine a role for a client device coupled to a first port of computer system 600. The role of the client device may be determined based on the authentication credentials from the client device via the first port. In the example of FIG. 1A, network device 112 can receive the authentication credentials from client device 122 via port 132. Based on the authentication credentials, network device 112 can determine role 152 for client device 122.

Telemetry instructions 618 may also include instructions 622 to determine a set of telemetry parameters associated with the role. The set of telemetry parameters may be determined based on a mapping between the role and the set of telemetry parameters stored in a data structure of computer system 600. In the example in FIG. 1A, network device 112 can store a mapping between role 152 and a set of telemetry parameters 162 in a data structure in the memory of network device 112. Furthermore, telemetry instructions 618 may also include instructions 624 to determine a flow identifier of a data flow received from the client device via the first port. The flow identifier can include a tuple [source IP address, destination IP address, source protocol port, destination protocol port, transport protocol]. In the example in FIG. 1A, network device 112 can determine a flow identifier for data flow 142 received from client device 122 via port 132.

Telemetry instructions 618 may include instructions 626 to identify a respective packet in the data flow associated with the flow identifier. If the IP addresses, ports, and transport protocol of the flow identifier are detected in a packet, that packet can be in the data flow. In the example in FIG. 1A, network device 112 can detect the IP addresses, ports, and transport protocol of the flow identifier of data flow 142 in packet 140. Hence, network device 112 can determine packet 140 to be in data flow 142.

Moreover, telemetry instructions 618 may include instructions 628 to record, based on the telemetry process of computer system 600, respective values of the set of telemetry parameters from the packet. Computer system 600 can run an application, such as an IPFIX daemon, comprising the telemetry process by recording the values of the set of telemetry parameters from the packet. In the example in FIG. 1A, network device 112 can use application 130 to record respective values of set of telemetry parameters 162 from packet 140. Data 630 can include any data that is required as input, or that is generated as output by the methods, operations, communications, and/or processes described in this disclosure. Specifically, data 630 can include information indicating a set of roles defined in a network and corresponding sets of telemetry parameters. Data 630 can also include respective mappings between the roles and the corresponding sets of telemetry parameters (e.g., the mappings in mapping data structure 250 of FIG. 2).

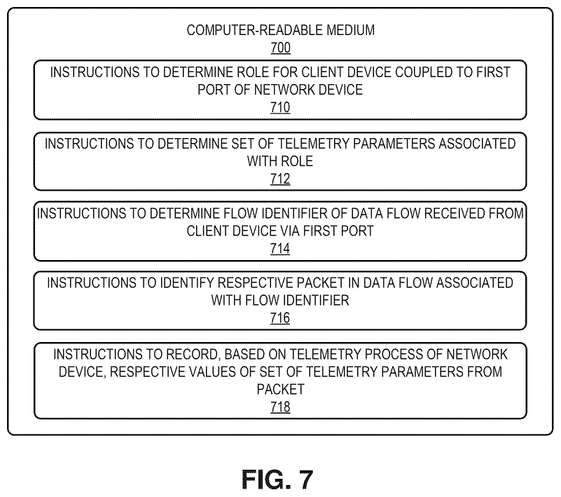

Computer system 600 and telemetry instructions 618 may include more instructions than those shown in FIG. 6. For example, telemetry instructions 618 can also store instructions for determining a reverse data flow 144 received at port 134 of network device 112 of FIG. 1A; recording respective values of telemetry parameters 162 from the packets of data flow 144 of FIG. 1A; performing DPI on packet 140 FIG. 1A; upon detecting roaming client device 122 at port 136 of FIG. 1B, using the telemetry process for recording respective values of telemetry parameters 162 from the packets received at port 136; storing a mapping between role 252 and corresponding set of telemetry parameters 262 in a mapping data structure 250 of FIG. 2; the operations depicted in the flowcharts of FIGS. 3, 4, and 5; and the instructions of non-transitory CRM 700 in FIG. 7.

FIG. 7 illustrates an example of a CRM facilitating role-based telemetry, in accordance with an aspect of the present application. CRM 700 can include one or more non-transitory computer-readable mediums or devices storing instructions that when executed by a computer or processor cause the computer or processor to perform a method. Therefore, the instructions in CRM 700 can be stored in one or more non-transitory computer-readable mediums or devices. CRM 700 can store instructions 710 to determine a role for a client device coupled to a first port of a network device. In the example of FIG. 1A, network device 112 can receive the authentication credentials from client device 122 via port 132. Based on the authentication credentials, network device 112 can determine role 152 for client device 122. CRM 700 can also include instructions 712 to determine a set of telemetry parameters associated with the role. In the example in FIG. 1A, network device 112 can store a mapping between role 152 and a set of telemetry parameters 162 in a data structure in the memory of network device 112.

CRM 700 can include instructions 714 to determine a flow identifier of a data flow received from the client device via the first port. The flow identifier can include a tuple [source IP address, destination IP address, source protocol port, destination protocol port, transport protocol]. In the example in FIG. 1A, network device 112 can determine a flow identifier for data flow 142 received from client device 122 via port 132. CRM 700 can also include instructions 716 to identify a respective packet in the data flow associated with the flow identifier. In the example in FIG. 1A, network device 112 can detect the IP addresses, ports, and transport protocol of the flow identifier of data flow 142 in packet 140. Hence, network device 112 can determine packet 140 to be in data flow 142.

Furthermore, CRM 700 can include instructions 716 to record, based on the telemetry process of the network device, respective values of the set of telemetry parameters from the packet. The network device can run an application, such as an IPFIX daemon, comprising the telemetry process by recording the values of the set of telemetry parameters from the packet. In the example in FIG. 1A, network device 112 can use application 130 to record respective values of set of telemetry parameters 162 from packet 140.

CRM 700 may include more instructions than those shown in FIG. 7. For example, CRM 700 can also store instructions for determining a reverse data flow 144 received at port 134 of network device 112 of FIG. 1A; recording respective values of telemetry parameters 162 from the packets of data flow 144 of FIG. 1A; performing DPI on packet 140 FIG. 1A; upon detecting roaming client device 122 at port 136 of FIG. 1B, using the telemetry process for recording respective values of telemetry parameters 162 from the packets received at port 136; storing a mapping between role 252 and corresponding set of telemetry parameters 262 in a mapping data structure 250 of FIG. 2; the operations depicted in the flowcharts of FIGS. 3, 4, and 5; and the instructions of computer system 600 in FIG. 6.

The description herein is presented to enable any person skilled in the art to make and use the invention, and is provided in the context of a particular application and its requirements. Various modifications to the disclosed examples will be readily apparent to those skilled in the art, and the general principles defined herein may be applied to other examples and applications without departing from the spirit and scope of the present invention. Thus, the present invention is not limited to the examples shown, but is to be accorded the widest scope consistent with the claims.

One aspect of the present technology can provide a network device in a network. During operation, the network device can determine a role for a client device coupled to a first port of the network device. The network device can then determine a set of telemetry parameters associated with the role. The network device can also determine a flow identifier of a data flow received from the client device via the first port. Subsequently, the network device can identify a respective packet in the data flow associated with the flow identifier. The network device can then record, based on a telemetry process of the network device, the set of telemetry parameters associated with the packet.

In a variation on this aspect, the network device can identify, at an upstream port of the network device, a reverse data flow destined to the client device based on the flow identifier. The network device can then record, based on the telemetry process, the set of telemetry parameters from a respective packet in the reverse data flow received at the upstream port.

In a variation on this aspect, the network device can detect the client device at a second port of the network device. The network device can then record, based on the telemetry process, the set of telemetry parameters from a respective packet received from the client device via the second port.

In a variation on this aspect, the network device can maintain, in a data structure, a mapping between the role and the set of telemetry parameters. Here, a respective entry of the data structure can include a mapping between a role and a corresponding set of telemetry parameters.

In a variation on this aspect, the network device can determine the role of the client device based on authentication credentials received from the client device from the first port.

In a variation on this aspect, the flow identifier can include one or more of: a source IP address, a destination IP address, a source protocol port, a destination protocol port, and a transport protocol.

In a variation on this aspect, to record the set of telemetry parameters, the network device can perform a DPI on the packet and record, based on the DPI, respective values of the set of telemetry parameters from the packet.

In a variation on this aspect, the network device can forward the set of telemetry parameters recorded from the packet to a collector device.

In a variation on this aspect, the network device can determine whether telemetry is enabled for the role. If telemetry is enabled for the role, the network device can record, based on the telemetry process, the set of telemetry parameters from the data flow.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disks, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

The methods and processes described herein can be executed by and/or included in hardware logic blocks or apparatus. These logic blocks or apparatus may include, but are not limited to, an application-specific integrated circuit (ASIC) chip, a field-programmable gate array (FPGA), a dedicated or shared processor that executes a particular software logic block or a piece of code at a particular time, and/or other programmable-logic devices now known or later developed. When the hardware logic blocks or apparatus are activated, they perform the methods and processes included within them.

The foregoing descriptions of examples of the present invention have been presented only for purposes of illustration and description. They are not intended to be exhaustive or to limit this disclosure. Accordingly, many modifications and variations will be apparent to practitioners skilled in the art. The scope of the present invention is defined by the appended claims.

What is claimed is:

1. A method, comprising:
determining, by a network device, a role for a client device coupled to a first port of the network device;
determining a set of telemetry parameters associated with the role;
determining a flow identifier of a data flow received from the client device via the first port;
identifying a respective packet in the data flow associated with the flow identifier; and
recording, based on a telemetry process of the network device, the set of telemetry parameters associated with the packet.

2. The method of claim 1, further comprising:
identifying, at an upstream port of the network device, a reverse data flow destined to the client device based on the flow identifier; and
recording, based on the telemetry process, the set of telemetry parameters from a respective packet in the reverse data flow received at the upstream port.

3. The method of claim 1, further comprising:
detecting the client device at a second port of the network device; and
recording, based on the telemetry process, the set of telemetry parameters from a respective packet received from the client device via the second port.

4. The method of claim 1, further comprising maintaining, in a data structure, a mapping between the role and the set of telemetry parameters, wherein a respective entry of the data structure comprises a mapping between a role and a corresponding set of telemetry parameters.

5. The method of claim 1, further comprising determining the role of the client device based on authentication credentials received from the client device from the first port.

6. The method of claim 1, wherein the flow identifier comprises one or more of:
a source Internet Protocol (IP) address;
a destination IP address;
a source protocol port;
a destination protocol port; and
a transport protocol.

7. The method of claim 1, wherein recording the set of telemetry parameters further comprises:
performing a deep-packet inspection (DPI) on the packet; and
recording, based on the DPI, respective values of the set of telemetry parameters from the packet.

8. The method of claim 1, further comprising forwarding the set of telemetry parameters recorded from the packet to a collector device.

9. The method of claim 1, further comprising:
determining whether telemetry is enabled for the role; and
in response to telemetry being enabled for the role, recording, based on the telemetry process, the set of telemetry parameters from the data flow.

10. A non-transitory computer-readable storage medium storing instructions to:
determine, by a network device, a role for a client device coupled to a first port of the network device;
determine a set of telemetry parameters associated with the role;
determine a flow identifier of a data flow received from the client device via the first port;
identify a respective packet in the data flow associated with the flow identifier; and
record, based on a telemetry process of the network device, the set of telemetry parameters associated with the packet.

11. The non-transitory computer-readable storage medium of claim 10, wherein the instructions are further to:
identify, at an upstream port of the network device, a reverse data flow destined to the client device based on the flow identifier; and
record, based on the telemetry process, the set of telemetry parameters from a respective packet in the reverse data flow received at the upstream port.

12. The non-transitory computer-readable storage medium of claim 10, wherein the instructions are further to:
detect the client device at a second port of the network device; and
record, based on the telemetry process, the set of telemetry parameters from a respective packet received from the client device via the second port.

13. The non-transitory computer-readable storage medium of claim 10, wherein the instructions are further to maintain, in a data structure, a mapping between the role and the set of telemetry parameters, wherein a respective entry of the data structure comprises a mapping between a role and a corresponding set of telemetry parameters.

14. The non-transitory computer-readable storage medium of claim 10, wherein the instructions are further to determine the role of the client device based on authentication credentials received from the client device from the first port.

15. The non-transitory computer-readable storage medium of claim 10, wherein the flow identifier comprises one or more of:
a source Internet Protocol (IP) address;
a destination IP address;
a source protocol port;
a destination protocol port; and
a transport protocol.

16. The non-transitory computer-readable storage medium of claim 10, wherein, to record the set of telemetry parameters, the instructions are further to:
perform a deep-packet inspection (DPI) on the packet; and
record, based on the DPI, respective values of the set of telemetry parameters from the packet.

17. The non-transitory computer-readable storage medium of claim 10, wherein the instructions are further to forward the set of telemetry parameters recorded from the packet to a collector device.

18. The non-transitory computer-readable storage medium of claim 10, wherein the instructions are further to:
determine whether telemetry is enabled for the role; and
in response to telemetry being enabled for the role, record, based on the telemetry process, the set of telemetry parameters from the data flow.

19. A computer system, comprising:
a processing resource;
a memory; and
a non-transitory computer-readable storage medium storing instructions that when executed by the processing resource cause the computer system to:
determine a role for a client device coupled to a first port of the computer system;
determine a set of telemetry parameters associated with the role;
determine a flow identifier of a data flow received from the client device via the first port;
identify a respective packet in the data flow associated with the flow identifier; and
record, based on a telemetry process of the computer system, the set of telemetry parameters associated with the packet.

20. The computer system of claim 19, wherein the instructions that when executed by the processing resource cause the computer system to:
identify, at an upstream port of the computer system, a reverse data flow destined to the client device based on the flow identifier; and
record, based on the telemetry process, the set of telemetry parameters from a respective packet in the reverse data flow received at the upstream port.
